(19) United States
(12) Patent Application Publication
(10) Pub. No.: US 2019/0258083 A1
(43) Pub. Date: Aug. 22, 2019

(54) Lens System for Vision Correction

(71) Applicant: PRES-BY VISION LTD., Tel-Aviv (IL)

(72) Inventors: Yair ALSTER, Tel-Aviv (IL); Omer RAFAELI, Udim (IL)

(21) Appl. No.: 15/112,177

(22) PCT Filed: Jan. 28, 2015
(86) PCT No.: PCT/IL15/50101

§ 371 Date: Jul. 17, 2016

Related U.S. Application Data
(60) Provisional application No. 61/932,255, filed on Jan. 28, 2014.

(51) Int. Cl. G02C 7/04

(52) U.S. Cl. CPC G02C 7/049; G02C 7/047; G02C 7/043

(57) ABSTRACT

A contact lens system is provided. The system includes a first lens configured for positioning over a cornea and a second lens positionable over the first lens. The system is configured such that the resistance to lateral movement of the first lens with respect to the cornea is higher than the resistance to lateral movement of the second lens with respect to the first lens.

### FIELD AND BACKGROUND OF THE INVENTION

The present invention relates to a lens system and, more particularly, to a contact lens system which can be used to correct vision problems such as presbyopia.

Typical vision problems such as myopia (nearsightedness), hyperopia (farsightedness) or presbyopia (loss of accommodation and subsequent loss of near and intermediate vision) are readily correctable using eyeglasses. However, some individuals prefer contact lenses for vision correction due to an active life style or aesthetic preferences.

Contact lens wearers who become presbyopic with age require additional corrective lenses to allow both near, intermediate and distance vision. While glasses provide a good optical solution for presbyopic contact lens wearers, eyeglasses can be less desirable by contact lens wearers for convenience and aesthetic reasons.

In attempts to provide a solution to this problem, contact lens makers have developed multifocal lenses which simultaneously focus light from a range of distances via several focal regions and bifocal lenses that include two simultaneously distinct lens powers, a central region for correction of myopia and a surrounding region for correction of hyperopia. The latter lenses translate with respect to the optical axis of the eye to provide both near and far vision correction depending on the eye gaze angle.

While bifocal and multifocal lenses can correct presbyopia, translation of the bifocal lens with respect to the cornea—anywhere from 2-6 mm (significantly more than standard contact lenses that typically translate about 0 to 0.5 mm)—can cause irritation and significant discomfort to the user while simultaneous focusing of light from several distances—as is the case for multi-focal lenses—requires the user to ‘process’ light coming in from several distances. Furthermore, anatomical variability with respect to the distance between the optical axis and lower lid margin necessitates individual fitting of lenses and patient adjustment to correctly align the near-vision correction region of the bifocal lens to the optical axis during near vision tasks.

The above problems of bifocal and multi-focal lenses can be theoretically traversed by using a two lens system in which a first lens is positioned on the surface of the cornea and a second, translatable lens is positioned over the first lens. However, providing a lens system in which an outer lens translates over an inner lens with the inner lens remains stable on the cornea while maintaining the entire lens system stable in the eye can be a challenging task.

Thus, it would be highly advantageous to have a lens system capable of correcting presbyopia while being devoid of the above limitations.

### SUMMARY OF THE INVENTION

According to one aspect of the present invention there is provided a contact lens system comprising a first lens configured for positioning over a cornea and a second lens positionable over the first lens, wherein a first interface between the first lens and the cornea and a second interface between the first lens and the second lens are each configured such that a resistance to movement of the first lens with respect to the cornea is higher than the resistance to the lateral movement of the second lens with respect to the first lens.

According to further features in preferred embodiments of the invention described below, a frictional force of the first interface between the first lens and the cornea is higher than that of the second interface between the first lens and the second lens.

According to still further features in the described preferred embodiments the second lens is attached to the first lens via a mechanism configured to allow lateral movement of the second lens with respect to the first lens.

According to still further features in the described preferred embodiments the mechanism includes at least one elastic connector.

According to still further features in the described preferred embodiments the mechanism is a deformable strut connecting an edge of the first lens to an edge of the second lens.

According to still further features in the described preferred embodiments the mechanism includes a rollable element interposed between the first lens to an edge of the second lens.

According to still further features in the described preferred embodiments the posterior surface of the second lens is displaced from an anterior surface of the first lens.

According to still further features in the described preferred embodiments a distance of displacement is 0.1-50 microns.

According to still further features in the described preferred embodiments a posterior surface of the first lens is configured for enhancing friction between the posterior surface and the cornea.

According to still further features in the described preferred embodiments an anterior surface of the first lens is configured for reducing friction in the second interface.

According to still further features in the described preferred embodiments a posterior surface of the second lens is configured for reducing friction in the second interface.

According to still further features in the described preferred embodiments the second interface is a fluid interface.

According to still further features in the described preferred embodiments the second interface is configured for uptake of tear fluid once the system is positioned in an eye.

According to still further features in the described preferred embodiments the second lens includes openings for uptake of the tear fluid into the second interface.

According to still further features in the described preferred embodiments the second lens includes a lid engaging element.

According to still further features in the described preferred embodiments the lid engaging element is configured for engaging an inner part of a lower lid edge when the system is positioned in an eye.

According to still further features in the described preferred embodiments the lid engaging element is a textured region on an anterior surface of the second lens or a ridge juxtaposed against a lower lid edge.

According to still further features in the described preferred embodiments the first lens is a zero power lens.

According to still further features in the described preferred embodiments the first lens has negative optical power.

According to still further features in the described preferred embodiments the first lens has positive optical power.

According to still further features in the described preferred embodiments the first lens has cylindrical optical power.

According to still further features in the described preferred embodiments the second lens includes at least two optical regions.

According to still further features in the described preferred embodiments each of the at least two optical regions has a different optical power.

According to still further features in the described preferred embodiments an optical power of the second lens changes over an area of the second lens.

According to still further features in the described preferred embodiments the second lens has a positive optical power.

According to still further features in the described preferred embodiments the second lens is a negative optical power.

According to still further features in the described preferred embodiments a posterior surface of the second lens includes silicone and an anterior surface of the first lens includes hydrogel.

According to still further features in the described preferred embodiments a posterior surface of the second lens includes hydrogel and an anterior surface of the first lens includes silicone.

According to still further features in the described preferred embodiments the second lens is fabricated from PMMA and the first lens is fabricated from a hydrogel or a silicone-hydrogel.

According to still further features in the described preferred embodiments a posterior surface of the first lens is configured for enhancing friction between the posterior surface and the cornea.

According to still further features in the described preferred embodiments the posterior surface of said first lens includes a material for enhancing friction between the posterior surface and the cornea.

According to still further features in the described preferred embodiments the material is silicone.

According to another aspect of the present invention there is provided a contact lens system comprising a first lens configured for positioning over a cornea and a second lens positionable over the first lens, wherein the system is configured such that an adhesion force between the first lens and the cornea is higher than the adhesion force between the first lens and the second lens.

According to yet another aspect of the present invention there is provided contact lens system comprising a first lens positionable over a cornea and a second lens positionable over the first lens, wherein a geometry of the first lens and a geometry of the second lens are selected such that an adherence of the first lens to a cornea is higher than an adherence of the second lens to the first lens.

According to still another aspect of the present invention there is provided a contact lens system comprising a first lens configured for positioning over a cornea and a second lens positionable over the first lens, wherein the system is configured such that a force applied by a lid on the system has a greater lateral component on the second lens than the first lens.

According to yet another aspect of the present invention there is provided a contact lens system comprising a first lens configured for positioning over a cornea and a second lens positionable over the first lens, wherein an anterior surface of the first lens is materially different from a posterior surface of the second lens.

According to still another aspect of the present invention there is provided a contact lens system comprising a first lens configured for positioning over a cornea and a second lens positionable over the first lens, wherein a geometry of the first lens and/or a geometry of the second lens are selected such that a geometric concentering forces of the first lens over the cornea are larger than the geometric concentering forces of the second lens over the first lens.

According to still another aspect of the present invention there is provided a contact lens system comprising a first lens configured for positioning over a cornea and a second lens positionable over said first lens, wherein the first lens includes two geometrically distinct zones for geometric centering the second lens in each of the two zones over the first lens.

The present invention successfully addresses the shortcomings of the presently known configurations by providing a lens system that includes a first lens positionable over a cornea and a second lens positionable over the first lens. The lens system is configured such that the second lens is translatable over the first lens without appreciable movement of the first lens over the cornea when the system is positioned in an eye and the eye is rotated up and down.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a-d illustrate the parameters defining interaction between a single and dual lens system and an eye. FIG. 1a illustrates the various force and pressure directions between a single lens and the eye. FIG. 1b illustrates the contact areas between a single contact lens and the cornea and eye lids. FIG. 1c illustrates the interaction of a two lens system with the eye components. FIG. 1d illustrates the lid and frictional forces on a two lens system positioned in the eye.

FIGS. 2-3 illustrate the present lens system in a gaze forward (FIG. 2) and gaze down (FIG. 3) positions showing displacement of the second lens over the first lens during gaze down.

FIG. 4 illustrates an embodiment of the present lens system which includes a lid engaging element on the second lens.

FIG. 5a-b illustrate an embodiment of the present lens system which includes a tether connecting the first and second lenses. The tether can be flat (FIG. 5a), or provided with a length accommodating structure such as an elbow (FIG. 5b).

FIG. 6 illustrates an embodiment of the present lens system which includes a friction reducing spacers interposed between the first and second lenses.

FIG. 7 illustrates an embodiment of the present lens system which includes second lens centering zones on the first lens.

### DESCRIPTION OF THE PREFERRED EMBODIMENTS

The present invention is of a lens system that can be used to correct visions in hyperopic, myopic or emmetropic individuals with presbyopia. Specifically, the present invention can be used to provide both near, intermediate and far vision while traversing comfort and usability problems of prior art bifocal and multifocal lenses.

The principles and operation of the present invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

Individuals who are contact lens wearers and become presbyopic during their mid forties find out that their contact lenses do not provide adequate solution for both near and distance vision tasks. Multifocal contact lenses as well as translating lenses (both rigid and soft) are available commercially but have not gained significant market share. Multifocal contact lens reduce vision quality while bifocal lenses require significant fitting effort and cause significant discomfort in many individuals.

Approaches for traversing limitations of presently used bifocal lenses have been described in the prior art. For example, US20080097600 describes a movable ophthalmic lens system which includes a carrier positionable on a portion of an eye, and a movable ophthalmic lens arranged for movement over a surface of the carrier. The assembly is configured such that the movable ophthalmic lens is responsive to ocular muscular movement so as to move in translatory motion over the surface of the carrier. Although this solution can in theory address comfort problems and provide near and far vision, it does not take into account the forces present in the eye environment (eyelid normal and lateral forces, as well as adhesion forces between the carrier and cornea and lens and carrier).

Another problem of current alternating contact lens for presbyopia is correct fitting for the distance between Lower Lid Margin to the center of pupil (LLM-COP). If the LLM-COP is larger than the ridge to the bifocal transition line, the lens won't translate enough to provide near vision. However, if the LLM-COP distance is too small, the patient may experience double vision (both focal distances are within the pupil area). Current bifocal contact lens solution require production of few sizes and matching to ensure correct fit, however, these lenses can still fail to provide adequate vision correction in clinical practice.

While reducing the present invention to practice, the present inventors have devised a contact lens system for correcting visions problems in, for example, presbyopic individuals. The present system includes a first lens positionable over the cornea and a second lens positionable over the first lens. In order to ensure that the first lens does not substantially move over the cornea awhile the second lens translates over the first lens, the assembly is configured so as to allow the second lens to move laterally with respect to the first lens, while the first lens remains substantially stable over the cornea. As is further described herein, such functionality is achieved by using different lens materials/coatings and/or different lens configurations and/or by providing the second lens with elements that convert forces applied thereupon by the lower lid into lateral movement of the second lens only.

Thus, according to one aspect of the present invention, there is provided a contact lens system for correcting vision problems such as presbyopia with or without correcting for additional refractive errors. In addition such lens system can provide a solution for low (near) vision magnification.

As used herein, the term “lens” refers to a light-passing element. The phrase “lens system” refers to two or more lenses that are formed from a single surface or two or more separate or attached surfaces. The lenses can be any shape and configuration and can have zero, negative or positive optical power as well as cylindrical power.

The lens system of the present invention includes a first lens configured for positioning over a cornea and a second lens positionable over the first lens. The lenses are configured such that a resistance to lateral movement of the first lens with respect to the cornea is higher than the resistance to lateral movement of the second lens with respect to the first lens.

In order to design a lens system capable of such functionality, the present inventors examined the forces on a single and two lens system positioned in an eye. In order to assess the motion of a contact lens in the eye environment, one must consider the forces and pressures acting on, and resulting from, the contact lens—eye environment interaction. Pressure and force values were derived from Roba et al. (Friction on contact lenses Tribol Lett 2011), Ming et al. (Centering mech. of soft lenses, 1999) and Young et al. (influence of soft contact lens design, 1993).

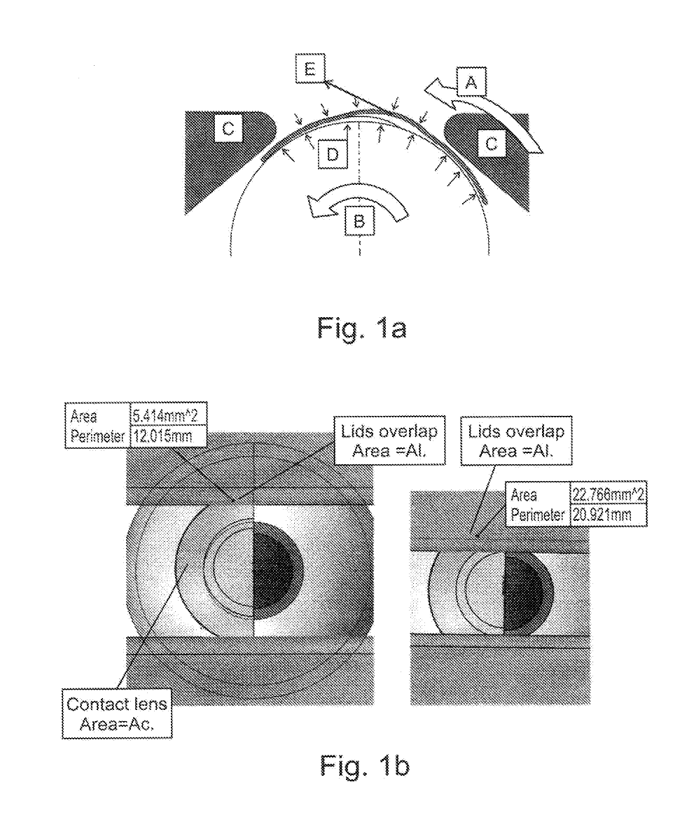

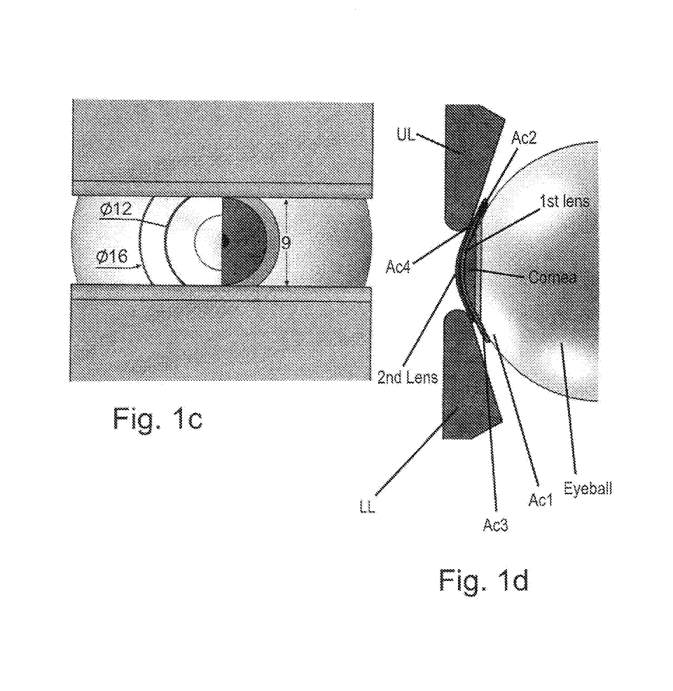

FIG. 1a illustrates the various forces and pressures on a contact lens positioned in an eye (contact lens shown displaced from lowest energy position). ‘A’ and ‘B’ are force inducing movements in side of the eye, where A is the rapid motion of the upper eyelid over the eye and ‘B’ is the motion of the eye in its socket (typically 1-1.2 mm/sec, reaction forces are maximal at slow velocity of 0.1 mm/sec) ‘C’ is the normal pressure of the lids on the Eye (3-5 kPa) and ‘D’ is the contact pressure of a contact lens on to the eye with the presence of the mucus membrane (2-6.5 kPa). E is the self-aligning force pushing to center a contact lens over the cornea when subjected to a forced dislocation (as shown). This force depends on the geometry of the lens and the degree of displacement and acts as a tensioned element with typical values of 2.5-2.75 mN/mm (in commercial soft lenses, assuming good contact to eyeball). All surface to surface contacts have a CoF [μi] that varies with choice of materials and surface smoothness. Standard soft contact lenses typically have values ranging from μ=0.05 to μ=0.6.

In order to calculate all the forces in play one must take in to consideration the surface area on which the difference forces and pressures apply.

FIG. 1b illustrates a single 14 mm lens having a surface area of approximately 170 mm² positioned in an eye. ‘Al’ represents the overlapping areas of the lids (˜22-80 mm²). The forces resulting from the pressure-area calculation (with reference to FIGS. 1a-b):

F[C]: Force resulting from ‘C’=“member pressure”*“Al”*“friction coefficient”=>{3÷5} KPa*{22÷80} mm²*{0.05÷0.6}={4÷240} mN: F[D]: Force resulting from ‘D’=“Contact pressure”×“Ac”×“friction coefficient”=>{2÷5} KPa*170 mm²*{0.05÷0.6}={17÷510} mN

The force resulting from geometry, F[E]=spring coefficient×Displacement=>{2.5÷2.75} [mN/mm]*{0−5} [mm]

The above forces were taken into consideration and applied to a two lens system designed for ensuring that the second (outer) lens moves over the first lens while the first lens remains relatively stationary over the cornea.

In other words, the two lens system must be designed in order to satisfy the following: F[C] @contact(Lid-Lens#2)>F[D] @contact(lens#1−Lens#2) and: F[D]@contact(lens#1−Layer#2)+F[C]@contact(Lid-lens#1)<F[D]@contact(lens#1−Eyeball)

The contact regions between a two lens system and eye parts are illustrated in FIGS. 1c-d. For calculation purposes, a two lens system including a 16 mm inner lens (first lens, #1) and a 12 mm outer lens (second lens, #2) were modeled. The eyelid gap (PFH) or distance between eyelid rims was set at 9 mm with the eyelids being stationary (no blinking or squinting). The contact pressure of the lids on both lenses is 4 kPa, the coefficient of friction (μ1) between eye parts (eyeball and Lids) and lenses is 0.5, the coefficient of friction (μ2) between the first Lens (inner) and the second Lens (outer) (at Ac2) is 0.1 and the contact pressure [interface Sheer stress (T)] is 3 kPa, for all surfaces.

The two lens system has four different areas of contact, Ac1—contact Area of lens #1 to Eyeball (For 16 mm Diameter ˜229 mm²), Ac2—contact area of lens #1 to lens #2 (For 12 mm Diameter ˜105.5 mm²), Ac3—contact area of lens #1 to Eyelids (For 16 mm Diameter and a 9 mm gap ˜70.5 mm²) and Ac4—contact area of lens #2 to Eyelids (For 12 mm Diameter and a 9 mm gap ˜10.6 mm²).

The calculated contact forces are as follows:

F[Ac1]=T*Ac1+[C]*Ac3=3*229+4*70.5=969 [mN]

F[Ac2]=T*Ac2+[C]*Ac4=3*105.5+4*10.6=358.9 [mN]

F[Ac3]=(T+[C])*Ac3=(3+4)*70.5=493.5 [mN]

F[Ac3]=(T+[C])*Ac2=(3+4)*10.6=74.2 [mN]

And the calculated friction forces over areas of contact are as follows:

Fμ[Ac1]=F[Ac1]*μ1=969*0.5=484.8 [mN].

Fμ[Ac2]=F[Ac2]*μ2=358.9*0.1=35.9 [mN].

Fμ[Ac3]=F[Ac3]*μ1=493.5*0.5=246.5 [mN].

Fμ[Ac4]=F[Ac4]*μ1=74.2*0.5=37.1 [mN].

A displacement force applied to lens #1 by the eyeball is depicted by an arrow in FIG. 1e. When the forces generated by friction over [Ac2] (lens#1 to lens#2) are significantly lower than those of [Ac4](lens #2 to lids), translation of lens #2 over lens #1 ([Ac2]) would not lead to movement of lens #2 under the lids ([Ac4]). When frictional forces generated by lens #1 sliding under [Ac2]+[Ac3] (total areas on exterior side of lens#1) are significantly lower than forces generated by sliding of the eyeball under lens#1, [Ac1] (posterior side of lens #1), than Lens #1 will not induce movement of Lens #2 and will slide under it, again contributing to translation of lens #2 over Lens #1.

Movement of lens #2 requires overcoming contact at region Ac2, where frictional forces are Fμ[Ac2]=35.9 [mN]. Fμ[Ac2]<Fμ[Ac4]; (35.9<37.1). The overall friction on exterior side of lens #1=Fμ[Ac2]+Fμ[Ac3]=35.9+246.5=282.4 [mN], since Fμ[Ac2]+Fμ[Ac3]<[Ac1]; (282.4<484.8) motion will not occur over [Ac1] when motion is initiated over [Ac2] and [Ac3].

Several approaches can be used for providing near, intermediate and far vision correction in a lens system having a first lens that translates over a stable second lens. Such approaches can utilize one or more of the following:

(i) Surface properties—The materials of the first and second lenses and/or coatings of their surfaces (inner and outer surfaces of the first and second lenses) can be selected such that the interface between the first lens and the cornea and the first lens and second lens, as well as the interface between the first and second lenses and inner lid surfaces (lower and upper lid) exhibit a differential (static) coefficient of friction (CoF). Materials suitable for fabrication of the lenses include, but are not limited to hydrogel materials such as tefilcon, lidofilcon B, etafilcon, bufilcon A, tetrafilcon A surfilcon bufilcon A perfilcon crofilcon lidofilcon A deltafilcon A etafilcon A dimefilcon ofilcon A, droxifilcon A, ocufilcon Bhefilcon A & B xylofilcon A, phemfilcon A, phemfilcon A, phemfilcon A scafilcon A, ocufilcon, tetrafilcon B, isofilcon, methafilcon, mafilcon, vifilcon A,polymacon with the use of monomers such as HEMA, MMA, NVP, PVP, MA, PC, Modified PVA, PVA. Silicone Hydrogel materials can also be used such as but not limited to Balafilcon A or Lotrafilcon A with monomers such as NVP, TPVC, NCVE, PBVC, DMA, TRIS, siloxane macromere. Furthermore, rigid permeable gas contact lens material can also be used (see example 1). Furthermore, pure silicone lenses can be used (see example 3). Such silicone can be made at different rigidities ranging from Silicone Shore A 10 to silicone Shore A 95. Such materials can be selected to provide the differential friction between the lenses of the present system (further described hereinunder) or selectively coated with various material in order to meet such frictional constraints. Such materials can be further undergo surface treatment such as but not limited to plasma oxidation or include internal wetting monomers such as but not limited to PVP.

For example, the inner surface of the first lens can be fabricated from a material (e.g. Silicone) having a relatively high static CoF (against the cornea) to thereby increase the CoF of the first interface and the resistance of the first lens to lateral forces applied by the lids (further described herein below). The second lens can be fabricated from a material (e.g. Hydrogel) having a relatively low CoF (against the outer surface of the first lens) such that the second interface exhibits a static CoF which is lower than that of the first interface. This will ensure that the second lens translates over the first lens in the eye while the first lens remains stable (see Example 3). Another approach for decreasing the static CoF of the second interface is to fabricate the outer surface of the first lens from a hydrophilic material (e.g. hydrogel) and at least the inner surface of the second lens from a hydrophobic material (e.g. silicone).

Surface patterning can be used to provide different resistant to lateral forces in different direction by utilizing, for example a pattern of microscopic grooves, such that friction characteristics are different in different direction. Such a pattern can enables sliding in vertical directions and resistance to sliding in horizontal directions. Further control can be achieved, for example, by using a pattern of microscopic angled grooves, where the sliding resistance is different for each radial vector of movement.

The lenses can be composed of the same material with different surface treatment. The two lenses can also be of different materials. Also, each lens can also have one layer that is made of one material (e.g. Hydrogel) and another layer made of another material (e.g. Silicone). The contact area of any lens with its opposing surface can have similar properties over the entire contact area or it can have an area with one set or properties and at least one more area with different set of properties. Such properties can be achieved with combinations of materials, layers, coatings or surface treatments. In order to allow presence of fluid between the surfaces (e.g. in the second interface) while keeping the hydrophobic properties, the surfaces can have mixed hydrophobic and hydrophilic properties in different zones, for example hydrophobic surface with hydrophilic islands where a fluid droplet makes contact with the surface only at small isolated regions, prevent adhesion and reduce friction (K Hiratsuka, Journal of Physics: Conference Series 89 (2007)).

(ii) Lens geometry—The first and second lens can be configured such that the lenses can have less frictional resistance over specific regions of their contact areas and are more stable over other regions. The minimum potential energy of a lens (e.g. second lens) thus occurs when it is centered over the first lens geometry which induces minimum strain forces on the second lens. Such stable regions can be created while taking into account the shape and size of both lenses. In general, when a lens is not correctly positioned in the eye (mismatched geometry between cornea and lens), a strain is produced in the lens (in the structure and material) making the lens' position inherently unstable. This is why mal-positioned contact lenses migrate in the eye. In contrast, when geometries are matched, the strain on the lens material is minimal and thus the lens is more stable and resistant to movement. Thus, mismatching the geometry between the first and second lens can create regions of high translatability while matching geometries in other regions can create regions of relative stability. For example, a steep curvature of the first lens relative to the cornea (BC=8) and flat curvature (BC=10) of the second lens relative to the first lens can be used in order to stabilize the first lens and reduce the re-centering force for the second lens.

(iii) Lens size and geometry—the size of the first and second lenses can be selected such that the ratio between the surface area of the first interface and that of the second interface ensures that the force of friction created by the first interface is much higher than that created by the second interface. For example first lens can be of standard size of about 14 mm in diameter and second lens can have a diameter of about 7 mm Another example as has been provided above would be to have the first lens have a diameter of 16 mm and the second lens have a diameter of about 12 mm. In any case, a ratio of 5:1 to 1.5:1 between the area of the first lens and second lens (respectively) can be used to achieve differential translation of the second lens. Geometry can further enhance movement of the second lens over the first lens in a range of pupil-lower eyelid distances. For example, the first lens can be configured with two geometrical regions on its anterior surface for stabilizing the second lens—a central region for aligning the optical axis of the two lenses (during down gaze) and a peripheral region for stabilizing the second lens during forward gaze. These 2 stable regions may have different levels of minimum potential energy, by utilizing different curvatures (BCs) for each lens. The forces produced by the lower lid on the second lens during gaze down would then translate the second lens from the peripheral region to the central region for near vision correction.

(iv) Spacing between lenses—the first and second lenses can be spaced apart by protrusions formed on the outer surface of the first lens or inner surface of the second lens. Such protrusions would decrease the contact area between the lenses and allow the gap between the lenses formed thereby to fill with tear fluid. The spacing can be achieved as an example by having multiple protrusions extending from the inner surface of the second lens. Such protrusions can have a base of 100 microns in diameter and protrude to about 30 microns and anywhere from 10 microns to 100 microns. Such protrusions can be spaced at the periphery of the inner surface of the second lens to prevent optical aberrations in the center or they can be added in the center as well and be configured such that they do not produce optical aberration (e.g. blacken the protrusions). The protrusions can be spaced such that they allow spacing in the interface between first and second lens while not causing front second lens to locally deform and cause optical aberrations. Protrusions can also be extended from the front surface of the second lens at the area onto which the second lens is contacting at all gaze positions.

(v) Lens rigidity—the second lens can be made more rigid and also be geometrically made such that it vaults over first lens such that reduced contact areas exist between first and second lens. Such rigidity can be achieved using rigid gas permeable contact lens material or silicone with higher shore A such as Silicone shore A 60 or above.

In addition to the above, the second (outer) lens can include the following optional features:

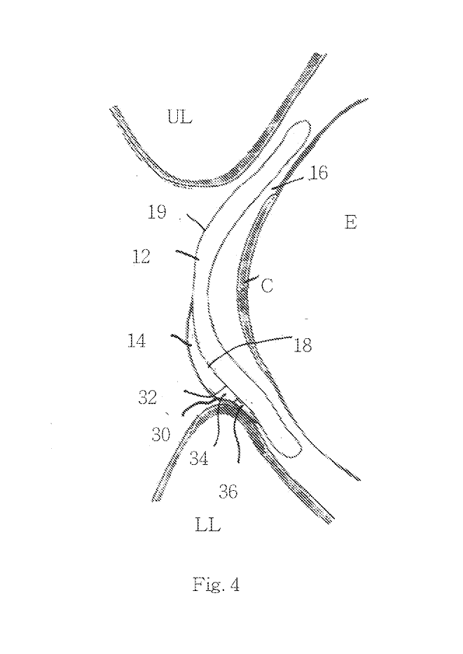

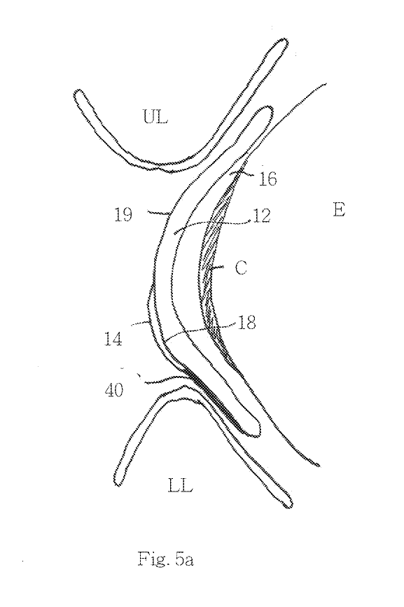

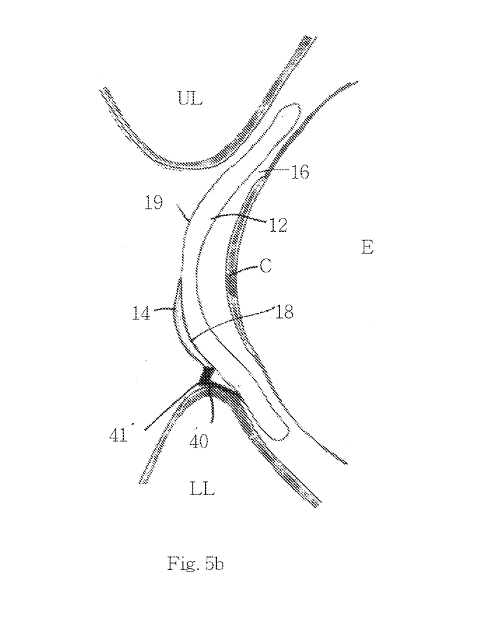

(i) Lid engagement elements—the second lens can include a protrusion or high friction region to engage the rim or inner surface of the lower lid during gaze down (see FIG. 4 below). A lid engagement element would increase the lateral forces applied to the second lens by the lower lid thus further contributing to the forces that overcome the static friction of the second interface. As is further described hereinbelow with respect to FIG. 5b, the lid engagement element can also be incorporated into a tether connecting the two lenses.

(ii) Pre-loading elements—in order to facilitate overcoming of the static friction of the second interface, the second lens can be connected to the first lens via a pre-tensioned tether. Such a tether can be tensioned by the lower eyelid when the second lens is located in the optical axis, on down gaze. On forward gaze, the second lens would more easily overcome the fictional engagement between the lenses and move back to home position. Alternatively, the pre-tensioned tether can be preloaded when the second lens is docked at the bottom during gaze forward. During gaze down the lower lid would then assist the second lens to move up and into the optical axis of the first lens under the pulling forces of the tether.

(iii) Fenestrations—the second lens can include micron-sized opening (fenestrations) to enable pumping of tear fluid into the second interface. Adding fenestrations into the second lens creates a path for increased flow of tear fluid through the fenestration and through the edges of the lens. In addition, forward pressure expressed by the lids during blinking creates a pumping effect whereas tear is pushed out and pulled in through such fenestrations (Kimberly L. Miller, Invest Ophthalmol Vis Sci. 2003; 44:60-67).

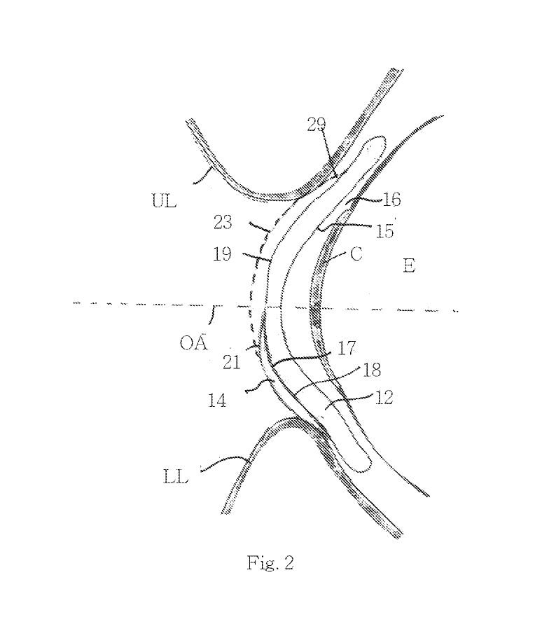

Each of the above features is described in greater detail with respect to the embodiments shown in FIGS. 2-7.

Referring now the drawings, FIGS. 2-7 illustrate several embodiments of the present lens system which is referred to herein as system 10. System 10 can be configured as a daily disposable lens system, an n extended wear lens system or a non-disposable lens system.

FIG. 2 illustrate the eye (E), cornea (C), lower lid (LL), upper lid (UL) and optical axis (OA) of the eye with respect to system 10 when the eye is in a gaze forward (far sight) position.

System 10 includes a first lens 12 mounted on the cornea and a seconds lens 14 mounted over first lens 12. The posterior (inner) surface 15 of first lens 12 is positioned against the corneal surface and forms a first interface 16 therewith. The posterior (inner) surface 17 of second lens 14 is positioned against the anterior (outer) surface 19 of first lens 12 and forms a second interface 18 therewith.

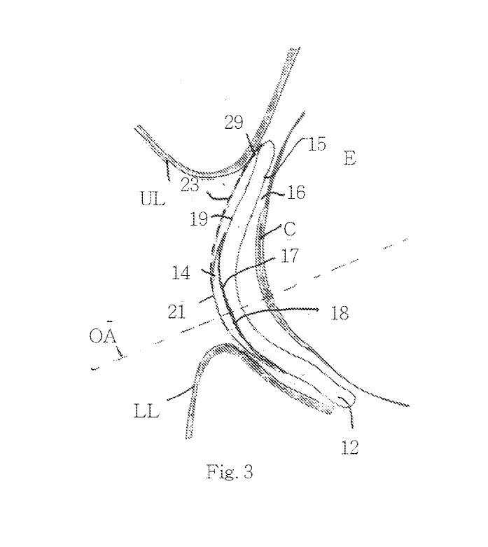

Second lens 14 of FIG. 2 is shown as having a relatively small surface area as compared to first lens 12 (e.g. about 1:6). However, it should be noted that a considerably larger second lens 14 (as indicated by dashed line 23, ratio about 1:2) can also be used in system 10. When a larger lens 14 is used, it is preferably large enough to be positioned under the UL when in gaze forward and gaze down (FIG. 3) such that the peripheral edge 29 of lens 14 does not bump against the lid rim during up-translation of lens 14. Peripheral edge 29 of lens 14 can also extend to cover the superior (top) edge of lens 12 during forward gaze such that during downward gaze the lid moves only against peripheral edge 29.

Due to gravitational forces lens 14 will position at the bottom of lens 12 next to the lower lid regardless of the orientation of lens 12 regardless if lenses 12 and 14 are tethered or not.

When the eye is in a gaze forward position, the optical axis of the eye runs through the optical center of lens 12 allowing far vision correction. Under the gaze forward eye position, the optical center of second lens 14 is displaced from the optical axis of the eye and as such second lens 14 does not provide any optical power to the light focused by the eye.

As is described hereinabove, system 10 is configured such that up and down movement of the optical axis of the eye (eye roll up and down) translates second lens 14 over first lens 12 while first lens 12 remains relatively stable over the cornea. Second lens 14 can translate a distance of 1-5 mm with respect to outer surface 19 of first lens 12 depending on the dimensions and configurations of lenses 12 and 14. While first lens 12 remains relatively stable throughout translation of second lens 14, some movement (up to 1 mm) can occur during eye movement and blinking. In any case, during eye movement the lateral movement (translation) of first lens 14 is greater than that of first lens 12 by a factor of at least 2.

FIG. 3 illustrate the eye (E), cornea (C), lower lid (LL), upper lid (UL) and optical axis (OA) of the eye with respect to system 10 when the eye is in a gaze down (near sight) position. As is shown by this Figure, gaze down translates second lens 14 upward enabling the optical center of second lens 14 to align with the optical axis of the eye and optical center of first lens 12, thereby providing near vision correction via the combined power of both first lens 12 and second lens 14.

As is described hereinabove, several approaches can be used to provide translation of second lens 14 over a relatively stable first lens 12.

In the embodiment shown in FIGS. 2-3, translation is provided by fabricating lenses 12 and 14 such that interfaces 16 and 18 exhibit differential resistance to lateral forces. As is described hereinabove, system 10 is subjected to a variety of forces when positioned in the eye. The forces exhibit normal and lateral components—the latter being pronounced during lid movement and eye movement. Thus, having a lens system 10 in which the frictional forces of first interface 14 are larger than that of interface 16 would result in translation of lens 14 only under such forces.

To ensure that second lens 14 translates over first lens 12 while the latter remains stable over the cornea, the frictional and/or the adhesion forces of first interface 16 as well as the centering, elastic forces of lens 12 should be greater than those of second interface 18.

Frictional forces are a function of the coefficient of friction (CoF), applied forces and area of interface, and adhesion is a function of surfaces as well as lenses geometries.

First lens 12 can be selected having a surface area larger than that of second lens 14 by a factor of 1.0-6.0. If the CoF of inner surfaces 15 and 17 are equal, the frictional force of first interface 16 would be larger than that of second interface 18. For example, in a system 10 including first lens 12 having a diameter of 14 mm and a second lens 14 having a diameter of 7 mm with both surfaces 15 and 17 fabricated from the same material with a CoF of N, the adhesion induced frictional force of first interface 16 would be about 5 times larger than that of second interface 18. If an equal lateral force is applied to both lenses 12 and 14 during gaze down, second lens 14 would translate over a relatively stable first lens 12.

The translation capabilities of second lens 14 can be further enhanced by fabricating lenses 12 and 14 having different outer and inner surface properties. Such surface properties can result from selection of materials or coatings, as well as be established via surface treatments.

For example, inner and outer surfaces 15 and 19 of first lens 12 can be hydrophilic (e.g. by fabricating lens 12 from a hydrogel), while inner surface 17 of second lens 14 can be hydrophobic (e.g. silicone). Thus, interface 16 would be hydrophilic-hydrophilic (due to mucin coating of the cornea), while interface 18 would be hydrophobic-hydrophilic. Tear fluid would imbibe both interfaces when system 10 is positioned in an eye. However, due to the different properties of interfaces 16 and 18, the tear fluid would increase static friction and adhesion in interface 16 and decrease static friction and adhesion of interface 16.

Outer surface 21 of second lens 14 is preferably made from known standard contact lens material and standard surface properties (e.g. hydrophilic hydrogel) in order to minimize friction and irritation of the inner surfaces of the lids during lid movement and eye roll.

The frictional properties of surface 19 can be unitary on the entire surface or only provided on a portion of surface 19. For example, a region of surface 19 can be fabricated with a relatively low CoF (e.g. 0.01-0.05), while another adjacent region can be fabricated with a relatively high CoF (e.g. 0.1-0.3). Such CoF patterning on surface 19 can be used to guide lens 14 movement.

FIG. 4 illustrates another embodiment of system 10 which includes a lid engagement element 30. Element 32 can be a ridge (ridge 32 shown in FIG. 4), an area of high friction or any other element capable of directing LL lateral forces on second lens 14.

Ridge 32 is configured for preventing lens 14 from moving under the lower lid during eye roll downward (gaze down). The use of such a ridge is known in the art. Single lens translating contact lenses include such ridges to enable the lens to translate over the cornea during gaze down. However, the ridge of single translating lenses can lead to user discomfort due to a relatively large contact region of about 8 mm between the ridge and the lower lid (LL) inner surface and rim.

In order to prevent such discomfort, ridge 32 of lens 14 is shaped such a contact area between ridge 32 and the rim and inner surface of LL is minimized.

For example, ridge 32 can include a protrusion 34 contiguous with a transition wedge 36. Protrusion 34 and wedge 36 can be formed on a portion of lens 14 such that the contact region between protrusion 34 and wedge 36 and the LL does not extend beyond 1 mm², preferably 0.1 mm². Protrusion 34 can protrudes 10-100 microns from surface 21 and is typically displaced from the LL rim during gaze forward, thereby not contacting and irritating the sensitive LL rim region. Wedge 36 which sits under the LL during gaze forward can be shaped as a wedge with a height transitioning from 100 microns to 10 micron towards the bottom of lens 14.

During gaze down, wedge 36 is pushed down until protrusion 34 abuts against the LL rim thereby concentrating the lateral forces applied by the LL on second lens 14 and enabling second lens 14 to translate up on surface 19 of first lens 12. It will be appreciated that a ridge 32 having a simple protrusion and no wedge region can also be used by the present invention and will further minimize interaction between ridge 32 and the lid and increase comfort.

As is mentioned hereinabove, element 32 can alternatively be a region of high friction on surface 21 of lens 14. For example, a peripheral region of surface 21 can be coated with a material having a high CoF (e.g. 0.3). Such a region is present under LL at all times to avoid rubbing of such area against UL during blinking During gaze down, the frictional forces created between this region and the LL would increase the lateral force component of the LL thereby translating lens 14 up over lens 12. Coatings with a high CoF include textured polymer (polyurethane) coating (forming microscopic brush-like projections), silicone coatings and the like.

FIG. 5a illustrates an element 40 which can used for connecting lens 14 to lens 12 (referred to herein as tether 40). Connection can be between any region of lenses 12 and 14. For example, the connection can be between rims of lenses 12 and 14, peripheral regions of lenses 12 and 14 or a combination of both. The region of connection can cover an arc (of lens 12 and/or 14) of 30, 60, 90, 120 degrees or more. A single region or multiple regions of connection can be used. Tether 40 can include one or more elastic band(s) attached to surface 19 (optionally at a rim of lens 12) and forming a part of lens 14 (e.g. contiguous with a rim thereof). When lens 14 translates over lens 12 during gaze down the elastic band(s) stretches to accommodate movement of lens 12, while gaze up returns the band(s) to its non-stretched state. Typical elastic accommodation for such a tether 40 can be 1 mm for every 10-100 micrograms of force. Another advantage of tether 40 is its ability to direct the movement path of lens 14 when it translates over lens 14.

Tether 40 can be fabricated from the material of lenses 12 or 14 or it can be attached (glued, welded) to lens 14 and optionally to lens 12 to form tether 40.

Tether 40 can include an elastic elbow region 41 (FIG. 5b) which abuts the rim of LL. Tether 40 can be 4 mm long, with elbow region 41 protruding 0.1-1 mm when lens 14 is docked at the bottom of lens 12 (as is shown in FIG. 5b). When lateral forces are applied to elbow region 41 by the LL (during gaze down), it linearizes and tether 40 elongates in the direction of lens 14 translation. During gaze up, tether 40 elastically returns to its previous state reforming elbow region 41. Alternatively, tether 40 can include an accordion-like region for accommodating for length changes or it can be fabricated from a highly elastic material (e.g. Shore 5 silicone) and accommodate length changes via stretching.

Tether 40 functions to maintain lens 14 at a predetermined position with respect to lens 12 and prevent lens 14 from coming off lens 14. For example, tether 40 can maintain lens 12 at a peripheral region of surface 19 during gaze up.

A band-type tether 40 can also be used to preload lens 14 over lens 12. Such preloading would decrease the lateral force needed to overcome static friction of interface 18. A band providing such force preloading is attached to a region of surface 19 above lens 14 and out of the optical center of lens 12. Such attachment can be facilitated via a Y-shaped band having arms disposed flanking the optical center of lens 12. Preloading force is selected suitable for maintaining lens 14 at the bottom of lens 12 (under gravity and friction) while providing enough force to substantially decrease the lateral force needed to overcome friction and gravity.

As is mentioned above, tethering of lenses 12 and 14 is advantageous since it maintains lens 14 at a predetermined position over lens 14 and prevents lens 12 from coming off lens 14. Such a feature of the present invention can alternatively be provided via other lens-engagement elements. For example, lens 14 can be provided with a groove/notch for receiving a bump on surface 19 of lens 12. The groove-bump engagement would act as a rail for guiding lens 14 during translation and provide correct lens 14 positioning during rest (gaze forward) while preventing escape of lens 12 from surface 19. Another configuration of system 10 can include a raised rim on a peripheral region of surface 19 for trapping lens 14 within lens 12. Such configurations do not permanently attach lenses 12 and 14 but rather provide an entrapment and guiding functions.

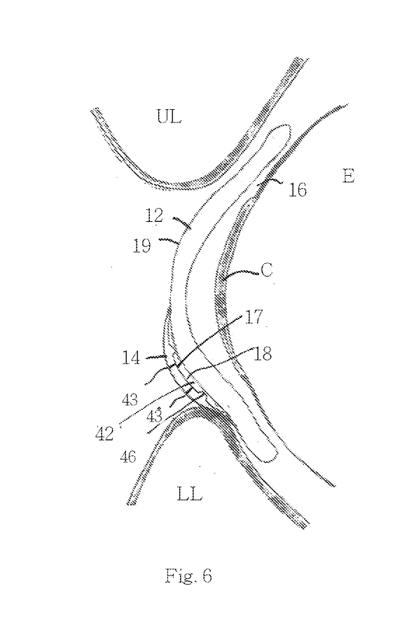

FIG. 6 illustrates another embodiment of system 10 which includes a gap 42 between lens 12 and 14. Gap 42 functions in reducing the frictional force of interface 18. Gap 42 can be formed by selecting the geometries of surfaces 19 and 21 of lenses 12 and 14 (respectively) or by interposing elements 46 between lenses 12 and 14.

For example, the shape of surface 19 at the lower region (under lens 14 during gaze down) can be substantially flat, while surface 17 of lens 14 can be steep (BC of about 8). In such a configuration of system 10, only a portion of surfaces 17 and 19 contact when lens 14 is placed over lens 12.

In the Example shown in FIG. 6, lens 14 includes inward-projecting elements 46 for displacing surface 17 from surface 19. Elements 46 can alternatively form a part of lens 12 or they can be non-attached elements trapped between lenses 12 and 14. In any case, elements can function in reducing the contact area and/or in providing a roller bearing-type function. Gap 42 can be 0.1-20 microns and can imbibe with tear fluid following placement of system 10 in the eye. Gap 42 can pump in tear fluid through fenestrations 43 (about 100 microns in diameter) in lens 14 via lid movement (as described hereinabove). Gap 42 can alternatively function as a reservoir for a lubricating fluid filled during or following system 10 fabrication. The lubricating fluid can be water, a buffer, a hydrophilic polymer, an oil or the like with excellent optical clarity so as not to distort vision. Since gap 42 moves across surface 19 during lens 14 translation, a system 10 which includes a lubricating fluid is preferably constructed such that the lubricating fluid does not escape the reservoir or adheres to surface 19 during translation. For example, the contact rim of lens 14 can be double ridged to prevent fluid escape and act as a wiper when lens 14 is translating over lens 14.

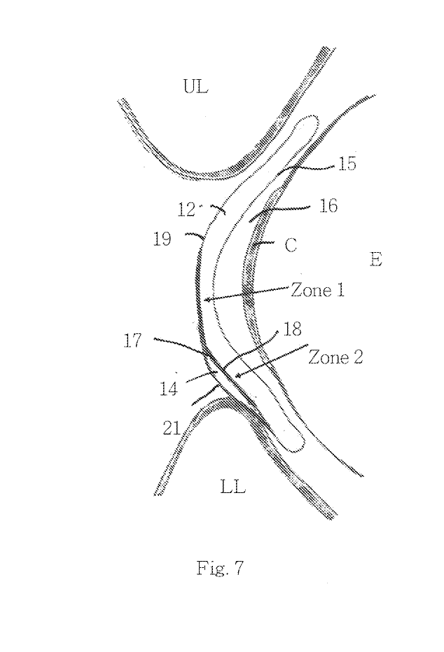

FIG. 7 illustrates yet another embodiment of system 10 which utilizes lens geometry to provide differential translation of lens 14.

Lens 12 of system 10 includes two zones (marked 1 and 2) that are geometrically configured for stabilizing the position of lens 14 (position on top of lens 12 and optionally rotational position of lens 14). Zone 1 is at the optical center of lens 12, while zone 2 is at the bottom of lens 12 (‘resting’ or ‘docking’ position for lens 14). Lens system 10 is configured such that lens 14 is capable of translating between zone 2 and 1 during gaze down and vice versa. When in a stable zone, lens 14 is more resistant to movement under lateral forces than when in a transition zone (in-between zone 1 and 2).

For example, in zone 1 the anterior surface of lens 12 can have a base curve of 10 mm and in zone 2 a base curve of 8.6 mm while lens 14 has a constant base curve of 8.6. During forward gaze lens 14 which has a natural tendency to be positioned over the matching base curve of zone 2 where it would rest and not create an additional optical power over lens' 12 optical power. During down gaze the lid forces will push lens 14 to move over zone 1 to provide the additional refractive power for nearer vision tasks. However, following return to forward gaze lens 14 will naturally slide down where base curves match is maximal.

Both zone 1 and zone 2 are stable zones for lens 14, however, one zone can be more stable than the other. For example, zone 2 can be more stable than zone 1 to facilitate return of lens 14 when returning from down gaze to forward gaze. In another example zone 1 can be more stable than zone 2 which would facilitate movement of lens 14 to its near vision position over the optical axis of lens 14.

Alternatively both zones can be with similar stability in respect to lens 14 with a transition zone between zone 1 and zone 2 that is less stable for lens 14 than either zone 1 or zone 2. Such configuration will facilitate position of lens 14 at either zone 1 or zone 2 but less on other undesired positions. Furthermore, zone 1 and zone 2 are more stable than the peripheral zones of lens 12 in respect to base curve of lens 14 to facilitate movement of lens 14 back to either zone 1 or zone 2 when lens 14 slides outside of such zones. Although use of two spatially displaced zones is preferred, a lens 12 having one such zone or more than two zones is also envisaged herein.

As is mentioned hereinabove, each of lenses 12 and 14 can have zero optical power, a positive optical power or a negative optical power with each lens having one or more optical centers. For example, lens 12 can have a single optical center with negative optical power for far vision correction (e.g. −1.0 to −5.0 Diopters), while lens 14 can have a single optical center with positive optical power for near vision correction (e.g. +1.25 to +4.0 Diopters) or two or more optical centers with positive optical powers for intermediate and near vision corrections. Lenses 12 and 14 can also have cylindrical powers (different vertical and horizontal powers).

The present lens system can be used by an individual by positioning lens 12 over the cornea and lens 14 over lens 12. Alternatively both lenses can be positioned in the eye as a single assembly.

The present lens system can be fabricated using well known approaches such as injection molding, vacuum forming and the like. Approaches used for fabricating multifocal lenses can also be used in the present invention. Each lens 12 and 14 can be fabricated separately or both lenses 12 and 14 can be fabricated as a single surface which can then be manipulated (e.g. folded) to provide lens system 10.

Coating of materials on the inner and outer surfaces of the lenses can be effected using plasma deposition and the like. The first and second lenses of the present lens system can be fabricated separately and then optionally connected or the lenses can be fabricated as a single surface.

As used herein the term “about” refers to 10% margins.

Additional objects, advantages, and novel features of the present invention will become apparent to one ordinarily skilled in the art upon examination of the following examples, which are not intended to be limiting.

### EXAMPLES

Reference is now made to the following examples, which together with the above descriptions, illustrate the invention in a non limiting fashion.

### Example 1

### Two Lens System—RGP Over Hydrogel

A bifocal RGP [fluorosilicone acrylate (fsa) made by “Fused Kontacts”] lens was positioned over a soft hydrogel contact lens positioned in an eye of a subject and movement and comfort parameters were evaluated over a period 3 days for 3-4 hours each day.

The RGP lens translated easily over the hydrogel lens while the hydrogel lens showed very little movement with respect to the cornea. This two lens system provided far vision correction when the user gazed forward and near vision correction when the user gazed down. The RGP lens was not stable and repeatedly fell out of the eye or slid into the upper or lower fornix. The lenses also periodically adhered together creating one moving complex which led to the loss of near vision. The user reported discomfort following 3 hours of wear time possibly due to insufficient oxygen permeation and lens adherence.

### Example 2

### Two Lens System—GelFlex™ Over Hydrogel

A bifocal alternating soft hydrogel contact lens (“Gelflex”) was positioned over a soft hydrogel contact lens positioned in an eye of a subject and movement and comfort parameters were evaluated over a period of 1 hour.

The lenses adhered together almost immediately and thus did not provide any near vision correction. Furthermore, the adhered complex caused discomfort during down gaze due to the rubbing of the Gelflex ridge on and below the lower lid (felt by the subject) and rubbing of the standard hydrogel lens over the cornea (corneal staining observed following removal of the lens)

### Example 3

### Two Lens System—GelFlex™ Over Silicone

A bifocal alternating soft hydrogel contact lens (“Gelflex”) was positioned over a pure silicone contact lens positioned in an eye of a subject and movement and comfort parameters were evaluated over 30 minutes.

The Gelflex lens moved smoothly over the silicone lens with no apparent adherence over 30 minutes at all gaze directions. The silicone lens did not appreciably move over the cornea. The system provided good distance and near optical performance (at down gaze of about 45%). With normal blinking the soft contact lens moved about 0.5 mm over the silicone lens, while gazing down to perform a near vision task, the soft lens moved about 3-4 mm with respect to the silicone lens. During the relatively short wear time, the lens system was stable. However, at longer wear times (30 minutes), the soft lens slid sideways into the lower fornix, however no adherence between the lenses was observed.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A contact lens system comprising a first lens configured for positioning over a cornea and a second lens positionable over said first lens, wherein a first interface between said first lens and said cornea and a second interface between said first lens and said second lens are each configured such that a resistance to lateral movement of said first lens with respect to said cornea is higher than said resistance to said lateral movement of said second lens with respect to said first lens.

2. The system of claim 1, wherein a frictional force of said first interface between said first lens and said cornea is higher than that of said second interface between said first lens and said second lens.

3. The system of claim 1, wherein said second lens is attached to said first lens via a mechanism configured to allow lateral movement of said second lens with respect to said first lens.

4. The system of claim 3, wherein said mechanism includes at least one elastic connector.

5.-6. (canceled)

7. The system of claim 3, wherein said posterior surface of said second lens is displaced from an anterior surface of said first lens.

8. The system of claim 7, wherein a distance of displacement is 0.1-50 microns.

9. The system of claim 1, wherein a posterior surface of said first lens is configured for enhancing friction between said posterior surface and said cornea.

10. The system of claim 1, wherein an anterior surface of said first lens is configured for reducing friction in said second interface.

11. The system of claim 1, wherein a posterior surface of said second lens is configured for reducing friction in said second interface.

12. The system of claim 1, wherein a posterior surface of said first lens is configured for enhancing friction between said posterior surface and said cornea.

13-14. (canceled)

15. The system of claim 1, wherein said second interface is a fluid interface.

16. The system of claim 1, wherein said second interface is configured for uptake of tear fluid once the system is positioned in an eye.

17. The system of claim 16, wherein said second lens includes openings for uptake of said tear fluid into said second interface.

18. The system of claim 1, wherein said second lens includes a lid engaging element.

19. The system of claim 18, wherein said lid engaging element is configured for engaging an inner part of a lower lid edge when the system is positioned in an eye.

20. The system of claim 18, wherein said lid engaging element is a textured region on an anterior surface of said second lens or a ridge juxtaposable against a lower lid edge.

21-29. (canceled)

30. The system of claim 1, wherein a posterior surface of said second lens includes silicone and an anterior surface of said first lens includes hydrogel.

31. The system of claim 1, wherein a posterior surface of said second lens includes hydrogel and an anterior surface of said first lens includes silicone.

32. The system of claim 1, wherein said second lens is fabricated from PMMA and said first lens is fabricated from a hydrogel or a silicone-hydrogel.

33-38. (canceled)
